(19) United States
(12) Patent Application Publication
(10) Pub. No.: US 2007/0050058 A1
(43) Pub. Date: Mar. 1, 2007

(54) Placemat for calculating and monitoring calorie intake

(76) Inventors: Zbigniew Zuziak, Brookfield, IL (US); Bozena Lasota, Brookfield, IL (US)

Correspondence Address: FACTOR & LAKE, LTD, 1327 W. WASHINGTON BLVD., SUITE 5G/H, CHICAGO, IL, 60607, US

(21) Appl. No.: 11/508,101

(22) Filed: Aug. 22, 2006

Related U.S. Application Data
(60) Provisional application No. 60/710,639, filed on Aug. 23, 2005.

(51) Int. Cl. G06F 17/00

(52) U.S. Cl. 700/90

(57) ABSTRACT

A placemat is disclosed having a scale, a calorie calculator, a memory for storing calorie and other nutritive intake history, and an interface that allows for communication and synchronization with outside computer entities.

### CROSS-REFERENCE TO RELATED APPLICATIONS

This application claims the benefit of U.S. Provisional Application No. 60/710,639, filed Aug. 23, 2005, herein incorporated by reference.

### TECHNICAL FIELD

The present invention is directed to a calorie consumption monitoring apparatus. More specifically, the present invention is directed towards a placemat that includes or communicates with a weighing means, a calorie calculator means, a memory means for storing calorie intake history, and an interface that allows for communication and synchronization with outside computer entities.

### BACKGROUND OF THE INVENTION

Recently, it seems that everyone is interested in finding a way to loose or maintain weight. Maintaining the proper weight is essential for healthy living. The important consequence of irrational eating among people is overweight and obesity, which in the United States has risen to an epidemic rate during the past years. Obesity has been linked to a higher risk of heart disease, diabetes and some forms of cancer. Overweight and obesity among people happens too often because it is difficult to control the quantity of calories consumed, which leads to overeating. There are some scales on the market known for defining the amount of calories in a particular produce or meal, but their structure and functions do not allow them to be used by a consumer any other way but as a scale.

Thus, there is a need for a device that can be easily and conveniently used by people to monitor and control the food intake over longer periods of time while also allowing for communication and receiving input from other devices.

### SUMMARY OF THE INVENTION

An inventive calorie consumption monitoring apparatus and method is disclosed herein. In an embodiment in accordance with the present invention, a placemat is provided having a scale, a calorie calculator, a memory for storing calorie intake history, and an interface that allows for communication and synchronization with outside computer entities.

Other embodiments, systems, methods, features, and advantages of the present invention will be, or will become, apparent to one having ordinary skill in the art upon examination of the following drawings and detailed description. It is intended that all such additional systems, methods, features, and advantages included within this description be within the scope of the present invention, and can be protected by the accompanying claims.

### BRIEF DESCRIPTION OF THE DRAWINGS

The invention may be better understood with reference to the following drawings. The components in the drawings are not necessarily to scale, emphasis instead being placed upon illustrating the principles of the invention. In the drawings, like reference numbers designate corresponding parts throughout.

FIG. 1 illustrates an embodiment of a placemat in accordance with the present invention for monitoring and management of food;

FIG. 2 is a block diagram illustrating an example set of components of the placement according to one example embodiment;

FIG. 3 is a flowchart describing a method for determining and monitoring calorie intake; and,

FIG. 4 is a flowchart describing an example method for monitoring calorie intake during a day and providing alerts when the amount consumed exceeds a preset limit.

### DETAILED DESCRIPTION

The following descriptions of detailed embodiments are for exemplifying the principles and advantages of the inventions claimed herein. They are not to be taken in any way as limitations on the scope of the inventions.

One application of an embodiment in accordance with the present invention is an immediate monitoring of calorie intake for food about to be consumed and tracking a number of calories consumed during a day or several days, so it makes a personal calorie tracking gadget with a personal calorie history stored in it. All the mat's functions are available for one or more people using the mat, after the proper logging in is done one person at a time, as described in greater detail below.

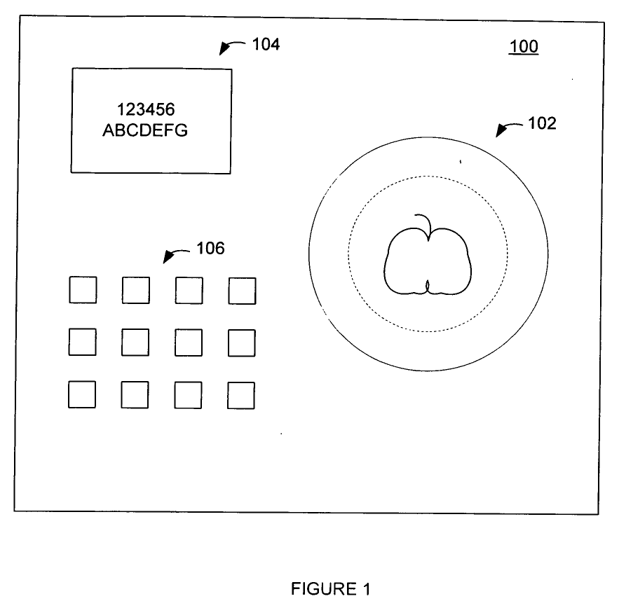

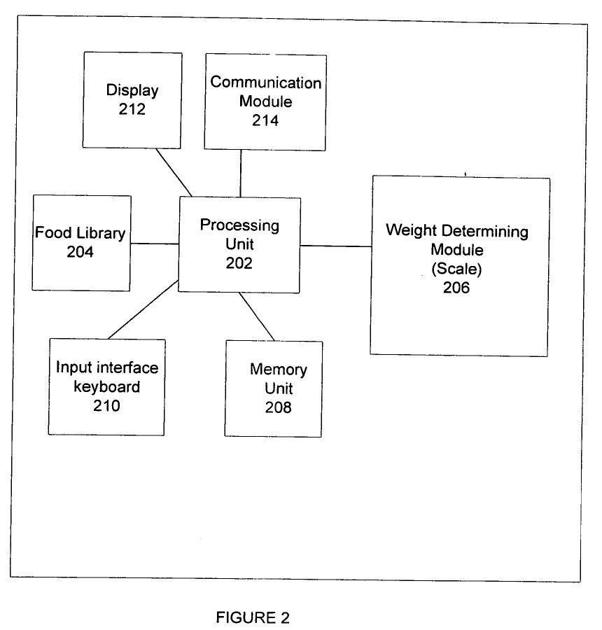

FIG. 1 illustrates an embodiment of a placemat 100 in accordance with the present invention. The placemat 100 can have the appearance of any conventional table placemat that may include or be in communication with components that will be described in detail in relation to FIG. 2. The shape, size, and weight of the placemat can vary based on the use preference, and the embodiments are not limited to any specific shapes, sizes, or materials to be used in relation to making the placemat of the embodiments. Preferably, the placemat is big enough so that a user can place food containers, such as plates, etc., on it. According to one embodiment, the placemat can be covered with a water resistant material so that it can be easily washed. Also, the placemat can be made of either flexible material, so that a user can easily carry it around or fold it. Alternatively, the material can be of fixed rigidity. The top appearance of the placemat is optional and different appearances can be used to make it desirable to a potential buyer.

The placemat includes a food placement area, shown at 102, an output area 104, and a user interface area 106. While, FIG. 1 shows specific positions of each area, it should be understood that each of these areas can be positioned at some other place on the placemat, so that for example, the food placement area 102 would be positioned on the left, while the other elements are positioned on the right side. Different embodiments are possible as well. According to one embodiment, the output area 104 includes an output means, such as a screen. The screen can be any conventional flat surface or yet some other screen that enables a user to view the displayed data. The screen can also be a touch-screen so that a user can manipulate and select certain things displayed thereon. It should be understood that rather than having a single food placement area, two or three different detection areas can be used so that a user can place more than one plate with different foods on each plate.

The user interface area 106 includes any input means, such a keyboard with a set of keys. One example input means can be standard calculator keys, with a set of selection inputs that enable a user to enter letters, numbers, etc.

According to one embodiment, the placemat 100 can be used by many different users, so that a user can select a log-in key to enter a user identifier, and then a log-out key once the user is done.

Some keys can correspond to different food groups that enable a user to quickly select a specific food type that the user will be consuming, such as chicken. Once the chicken is selected, there can be different options displayed in the screen area, such as fried chicken, cooked chicken, baked chicken, with each choice corresponding to a different key number. A user can then select a specific number to select a different chicken type.

The keyboard can also include a calorie key, which when selected, enables a user to view the calorie number of the food, and to display calorie number on the display screen. Additionally, a fat gram key can be selected in combination or in alternative with the calorie key so that a user can view either calories, and/or fat per meal on the screen.

There can also be additional standard calculator keys, such as (+), that enables a user to add additional items, such as when a user will be eating more than chicken during the meal.

It should be understood by those having ordinary skill in the art that different key options can be provided as well, and the embodiments set forth herein are not limited to any specific key selection set.

It will also be understood that the placemat can be either free-standing or can be built into some other entity, such as a table or another piece of furniture, to enable a person to control and monitor calorie as well as other nutrition value to be consumed and that has been consumed during a meal or throughout a day/week/month, etc. FIG. 2 is a block diagram illustrating a set of components of the placemat 200 according to one embodiment in accordance with the present invention. The placemat includes a central processing unit 202, a food library module 204, a scale module 206, a memory unit 208, a keyboard or other user input means 210, a display 212, and an outside communication interface module 214. While FIG. 2 shows specific interconnection between different elements, it should be understood that different embodiments with fewer or additional elements can also be used to accomplish the functions described herein.

The central processing unit 202 determines and monitors nutrition value intake according to an embodiment that will be described in greater detail below. For example, upon detecting a user input defining a food type to be consumed, and then detecting a weight input from the scale when a user places a plate with food on the scale 206, the processor obtains the calorie value and computes the calorie value for the food to be consumed. It should be understood that a weight of the plate can be first recorded and then subtracted from the total weight of the food and the plate to obtain the accurate food weight to be used in the calculations. Also, a user can then enter a different food type and place it on the same plate so that the total weight reflects two types of food and the weight of the plate. The processor can then compute the actual calorie value of the added food by determining the weight of the added food (total-plate-weight of the first food type), and then querying the food library module for the nutrition value of the added food type, and computing the nutrition value (calories) of the added food. The processing unit can then add this value to the already determined value for the first food type to determine a total calorie intake for the meal. The processing unit 202 can provide the values to be displayed on the display 212 so that a user can make an informed decision as to whether the user wants to consume the provided amounts of foods. It should be understood that a user could also specify drinks, etc, in the similar manner, with the amount of liquid could be either weighed or a user could provide a glass equivalent amount that the user will be consuming.

According to one example embodiment, a user can keep the plate on the placemat during the meal. As such, the processing unit 202 monitors the food intake, by receiving periodical weight readouts from the scale 206, and computing the value of the food being consumed based on the weight. If more than one food is being consumed, the processor can be programmed to assume that each food type is being consumed in equal proportions. Alternatively, if more than one weighting area is provided on the placemat, such as two smaller plates can be weighed separately, the weight monitoring for each food can be more accurate as the food is being consumed, since the processor receives, for example, two separate weight inputs from the scale, with each input corresponding to each food type weight.

At the end of the meal, the processor may store the meal data in the memory unit 208. As mentioned earlier, the placemat can be used by multiple users, and each user can use a separate login that can be entered using the keyboard 210 with a number of keys corresponding to letters, names, numbers, etc. In such an embodiment, the memory unit 208 can store records for each individual user. The records can be divided per day, per month, or yet in some other fashion. For example, a user can program the mat to record and monitor the daily calorie intake. In such an embodiment, at the end of the meal, the processing unit 202 can add the calorie intake to the total of the day. The total value can be displayed at the end of the meal or yet upon detecting a user request to view it. For example, a key corresponding to the “Daily Intake” can be provided that, when selected, provides a readout of the daily nutrition intake, such as fat grams, calories, etc. Also, the user may also store the food types that the user consumed during the day, or month. For example, a user may wish to view how many grams of bread and a total calorie value corresponding to the bread that the user consumed during the entire week. It should be understood that the manner and what is stored in the memory unit 208 can depend on the user, so that a user, for example, could at the end of the meal use the keyboard 210 to select a key to store the consumed meal information to the daily record of the user. Alternatively, the data can be stored automatically.

According to one example embodiment, the placemat can also include outside communication interface module 214 that can be used to receive data from outside sources. The interface module 214 can be any interface module that allows for communication, synchronization, and receipt of data from outside sources, such as PDA, or other computers. For example, a user can use other gadgets for monitoring food intake and then transfer data to the placemat to keep the daily, weekly, or monthly records, etc. This function may be actually very helpful considering current trends when modern houses have a computer overseeing all domestic functions. The food consumption for the entire family can be provided based on data gathered by the placemat so that more accurate planning can be done as to what food the family consumes or what food the family should consume more, such as vegetables, fruits, etc.

The food library module 204 includes a library of different food types arranged for example, alphabetically, with each food type having a corresponding calorie, fat, or other nutrition values, or vitamin information corresponding thereto, and provided based on a specific weight or other measurement method. There are different methods in terms of how the food and the corresponding nutrition value could be stored or arranged in the module 204, and the invention is not necessarily limited to any specific method.

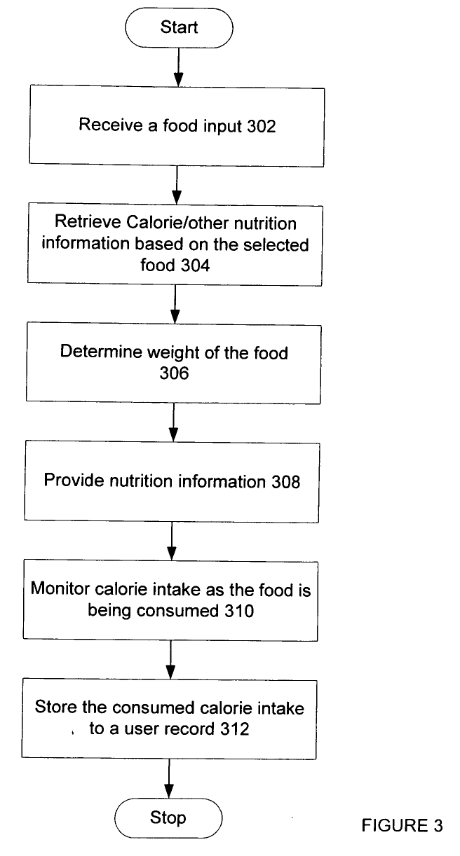

FIG. 3 is a flow chart illustrating an embodiment of a process of determining calorie intake for a food to be consumed. It should be understood that the invention is not necessarily limited to determining a calorie intake and different nutrition information, such as grams of fats, vitamins, etc.

At step 302, the processor detects a food name to be consumed. The food name can be received based on a user input via the keyboard. The food can be for example, chicken. In an embodiment, the user may only select a first letter of the food name and the possible choices could be displayed via the display. Upon detecting a chicken input, the display can also display different chicken styles, such as baked chicken, fried chicken, etc. to more accurately log the nutrition value. The choices can depend based on the available entries in the food library module 204. Each choice can be displayed with a number so that a user can select a specific number corresponding to the correct category. Different embodiments are possible as well, for example, a touch screen can be used.

At step 304, the processor 202 retrieves calorie information from the food library module 204. At step 306, the processor 202 receives the weight information from the scale. It should be understood that in an embodiment a user can first weigh the plate so that the plate weight can then be automatically subtracted from the weight of the total (food plus plate). At 308, the processor 202 can then provide the nutrition value, such as calories, for the food to be consumed. The nutrition value can be displayed to a user via the display 212. At step 310, as the food is being consumed, the processor can monitor the calorie intake. To do that the processor can periodically receive the weight readouts from the scale and then re-compute the food nutrition value based on the remaining weight. The food consumed nutrition value=initial value-current value. The processor 202 can provide the remaining calorie intake and the consumed calorie intake data to the display unit 212. At the end of the meal, such as upon detecting a “Finish” input, by a user selecting a “finish” or “stop” key via the keyboard 210, at step 312, the processor can store the consumed food information in the user-record in the memory unit 208. The information can be stored in the current day record created for the user. Also, as mentioned earlier, in an embodiment the processor 202 can add the consumed value to the user's daily record to keep track of the consumed calories during the day. It should be understood that a user can provide an identifier or log in with the identifier so that the processor 202 stores the data in the correct record, if more than one user uses the placemat.

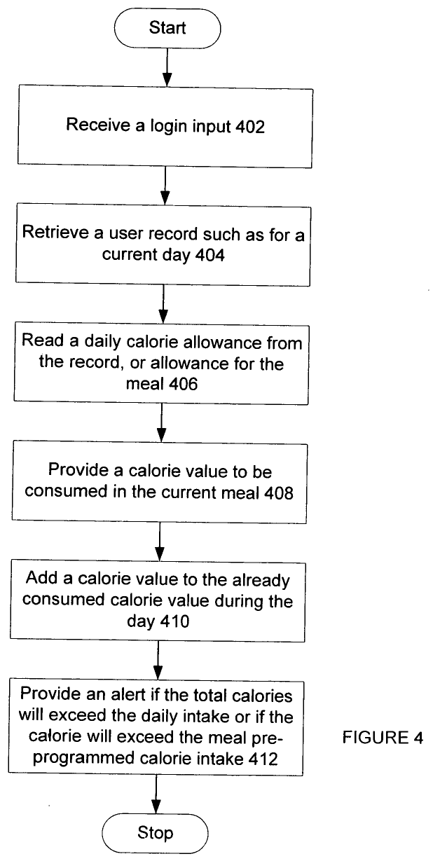

FIG. 4 is a flowchart that illustrates a method for monitoring food intake during a day, or yet some other time period.

At step 402, a user enters a log in with a user identifier to use a placemat. The identifier can be entered via a keyboard. Upon detecting the log in, the processor 202 retrieves user records, such as a current day record, as shown at 404. The user can, according to one embodiment, enter a profile, such as a number of calories a user is willing to consume during each day-it should be understood that a user could pre-enter the calorie intake for a longer period of times, such as each day of the week to plan ahead and follow a certain diet. As such, the processor retrieves a current day, using a calendar—in an embodiment, a user enters a current day when the user buys a placemat and then the processor tracks the days and time and automatically update the calendar. At step 406, the processor 202 reads a daily calorie allowance for the current day. It should be understood that rather than providing the daily allowance, in an embodiment, a user could enter a meal type, such as dinner, and similar allowance could be provided based on the meal type, depending on the user preferences. At step 408, the processor determines the calorie intake to be consumed in the current meal—using the method described in the preceding figure-by weighing the food to be consumed/determining the calorie value based on the selected food, etc. At step 410, the processor 202 adds the calorie to be consumed to the already consumed calories during the day. Alternatively, the processor 202 compares the calorie value to be consumed to the preset calories for the meal, such as a number of calories the user configured to be consumed for dinner. If the total number of calories (already consumed and to be consumed in this meal) is higher than the calories that the user preconfigured for the day, at step 412, the processor 202 generates an alert such as a message to be displayed on the display to a user that the user may potentially exceed the calorie value for the day by consuming the food placed on the placemat. Based on the alert, the user may decrease the food that the user will consume during the meal.

In another embodiment, is one user at a time logs in to enable to build his/her consumption history. Next, a plate or other dish used during food consumption is laid down on the mat in the spot where the scale is built in. Then, the scale with a plate or dish placed on the mat is set on zero with a keyboard key intended for this function. The plate or dish is filled with any amount of food watching its quantity/weight on the display monitor. With a keyboard keys a name of a produce is chosen from a produce library; it can be actually seen on the display monitor how many calories the chosen portion contains minus the weight of the plate. After accepting the needed amount of calories on the plate or dish, this particular amount of calories is entered to the memory where the calorie amount for any next individual produce will be added. The plate or dish is filled with food as we are monitoring it and accepting it to get the exact amount of calories we want to obtain for our meal to be consumed. When filling the plate or dish with a meal is completed, an individual chooses the option of what to monitor during a meal-the amount of calories remaining for consumption or the amount of calories already being consumed. If everything there is on the plate or dish was not consumed during a meal, the amount of calories left on the plate or dish would be more precise if the food products on the plate or dish were consumed evenly. The amount can be added to the calorie already consumed value during a day to keep the history in the memory.

It should be emphasized that the above-described embodiments of the present invention, particularly, any “preferred” embodiments, are possible examples of implementations merely set forth for a clear understanding of the principles for the invention. Many variations and modifications may be made to the above-described embodiment(s) of the invention without substantially departing from the spirit and principles of the invention. For instance, the present invention can be used for monitoring consumption of additional nutrients or items such as total fat, saturated fat, polyunsaturated fat, monounsaturated fat, cholesterol, sodium, total carbohydrate, dietary fiber, sugars, protein, vitamin A, vitamin C, iron, calcium, or the like. All such modifications are intended to be included herein within the scope of this disclosure and the present invention, and protected by the following claims.

What is claimed is:

1. An apparatus for monitoring consumption of a food item comprising:
a scale for weighing the food item;
a plurality of keys for entering data identifying the food item;
a display for displaying at least one nutrition fact about the food item in response to the identity and weight of the food item; and
an electronic memory for storing nutritional intake of an individual in response to the consumption of the food item.

2. The apparatus of claim 1 further comprising a placemat wherein the scale, the keys and the display are mounted to the placemat.

3. The apparatus of claim 1 further comprising a library of nutritional facts related to a plurality of foods, the nutritional facts comprising calories.

4. The apparatus of claim 3 further comprising a memory containing the library.

5. The apparatus of claim 1 wherein the electronic memory stores nutritional intake of different individuals.

6. The apparatus of claim 1 further comprising a communication module for exchanging data with an external electronic device, wherein at least a portion of the data is stored within the electronic memory.

7. The apparatus of claim 1 further comprising a processing unit for monitoring the nutritive nutritional intake of the individual.

8. The apparatus of claim 7 wherein the processing unit compares the nutritional intake with a nutritional allowance associated with the individual.

9. An apparatus for monitoring consumption of a food item comprising:
a placemat
a scale mounted to the placemat for weighing the food item;
a library of nutritional information related to a plurality of foods;
at least one key mounted to the placemat for corresponding the food item with one of the plurality of foods in the library;
a display mounted to the placemat for displaying the nutritional information for the food item in response to the identity and weight of the food item.

10. The apparatus of claim 9 further comprising a processing unit for comparing nutritional intake of an individual with a nutritional allowance.

11. The apparatus of claim 9 further comprising a communication module for exchanging data with an external electronic device, the data comprising the nutritional information.

12. A method comprising the steps of:
providing for weighing a food item;
receiving input identifying the food item;
displaying nutrients in the food item in response to the identity and weight of the food item and, monitoring nutrient intake of an individual by adding a consumed amount of nutrients in the food item to a previous total of consumed nutrient.

13. The method of claim 12 further comprising the step of mounting a scale, a plurality of keys and a display within a placemat wherein the scale provides for weighting the food item, the keys provide for receiving input identifying the food item, and the display provides for displaying the nutrients in the food item.

14. The method of claim 12 further comprising the step of providing a library of nutrient information related to a plurality of foods.

15. The method of claim 12 further comprising the step of providing a memory that contains nutrient information related to a plurality of foods.

16. The method of claim 12 further comprising the step of storing the nutrient intake of the individual within a memory.

17. The method of claim 16 further comprising the step of storing a nutrient intake of different individuals within the memory.

18. The method of claim 12 further comprising the step of using a communication module for exchanging data with an external electronic device, the data comprising the nutrient intake.

19. The method of claim 12 further comprising the step of monitoring nutrient intake of the individual.

20. The method of claim 19 further comprising the step of comparing the nutrient intake with a nutrient allowance associated with the individual.
